(19) United States
(12) Patent Application Publication
(10) Pub. No.: US 2007/0040299 A1
(43) Pub. Date: Feb. 22, 2007

(54) Method for producing a fibre-composite material for producing fibre-composite components

(76) Inventor: Ekkehard Roth, Winsen a.d. Luhe Deutschiand (DE)

Correspondence Address: GREENBLUM & BERNSTEIN, P.L.C., 1950 ROLAND CLARKE PLACE, RESTON, VA, 20191, US

(21) Appl. No.: 10/575,902

(22) PCT Filed: Jul. 14, 2005
(86) PCT No.: PCT/DE05/01247

§ 371 Date: Apr. 14, 2006

(30) Foreign Application Priority Data
Aug. 21, 2004 (DE) 10-2204-040.555.7
Oct. 29, 2004 (DE) 10-2004-052.552.8
Jan. 4, 2005 (DE) 10-2005-000-683.3

(51) Int. Cl. B29C 70/30

(52) U.S. Cl. 264/257; 264/258; 264/349

(57) ABSTRACT

The invention relates to a method for producing a fiber-composite material with one or more fillers added to the resin, in addition to reinforcement fibers added to the resin/filler mixture, whereby, apart from the fibers, ground fiber material as fiber ground material is added to the resin or the resin/filler mixture. The invention also relates to a sheet molding compound with a resin matrix system and reinforcement fibers and optionally fillers, whereby the fillers are ground material of the same material of which the reinforcement fibers are also composed.

The invention relates to a method for producing a fiber-composite material for producing fiber-composite components.

This fiber-composite material comprises the reinforcement fibers and a matrix with added fillers, whereby the matrix is a resin system. The use of fillers in combination with reaction resins is thereby used on a large scale.

Calcium carbonate, dolomite, kaolin, talc, quartz, wollastonite, aluminum hydrate, antimony trioxide, barite or hollow glass spheres are commonly used as fillers:

However, with the use of the fillers hitherto known in the prior art, it has not been possible to obtain a mirror-like surface of the fiber-composite component, i.e., a surface that meets today's requirements for a class A “visible component” in vehicle construction.

The object of the invention is therefore to propose a method with which better mechanical and optical properties (class A surfaces) can be realized with fiber-composite components and moreover production can be quicker, i.e., thus more cost-effective, than hitherto usual.

An essentially more homogenous component with more advantageous properties than hitherto usual is possible by using fillers of the material of the actual reinforcement fibers, e.g., carbon fibers. Moreover the component surface becomes very smooth, a surface of quality class A can thus be obtained, which is an important requirement for visible components in vehicle construction. No negative stresses occur with heat or cold, the component can later be recycled more easily and also more cost-effectively.

A material is added as filler to the resin, preferably comprising highly reactive reaction resins, i.e., the subsequent matrix, which material comprises the material of the actual reinforcement fibers. To this end the fiber material is finely ground or cut and added to the resin. The ground material preferably has a size of less than 2 mm and the cut fibers preferably have a size of less than 20 mm.

The invention further relates to a resin film with one or both of these specified fillers, i.e., the ground material or the cut fibers of the actual reinforcement fibers of the fiber-composite component. This resin film can be combined with textile semi-finished products, e.g., woven fabrics, braided fabrics, knitted fabrics, unidirectional or multiaxial laid fabrics.

It is also possible to combine the filler with a conventional prepreg, in which the filler is spread or blown onto the prepreg.

It is furthermore possible to apply the resin filler mixture by means of a spray method onto textile semi-finished products, e.g., woven fabrics, knitted fabrics, braided fabrics, unidirectional or multiaxial laid fabrics. These textile semi-finished products can then be further processed into, e.g., brief molds.

The invention further relates to a sheet molding compound. The sheet molding compound comprises a resin matrix system and reinforcement fibers and optionally fillers. According to the invention it is thereby provided that the filler or the additional filler is ground material of the material of which the reinforcement fibers are composed.

1. Method for producing a fiber-composite material for producing fiber-composite components, the fiber-composite material comprising reinforcement fibers, resin and a filler, the filler comprising at least one of ground and cut reinforcement fibers.

2. Method according to claim 1, wherein the filler comprises ground fibers having a particle size of less than 2 mm.

3. Method according to claim 1, wherein the filler comprises cut fibers having a size of less than 20 mm.

4. Method according to claim 1, wherein the at least one of ground and cut reinforcement fibers is mixed with the resin that forms a subsequent matrix of the fiber-composite component.

5. Method according to claim 4, wherein the resin filler mixture is processed into a film.

6. Method according to claim 5, wherein the resin filler film is applied to a semi-finished textile product.

7. Method according to claim 6, wherein the resin filler film is introduced into a component mold before the semi-finished textile product is placed in the component mold.

8. Method according to claim 1, wherein the fiber-composite material is applied into a component mold or onto a semi-finished textile product in a spray method.

9. Method according to claim 8, wherein the semi-finished textile product sprayed with the resin filler material is also used for producing preforms.

10. (canceled)

11. Method according to claim 6, wherein the semi-finished textile product comprises woven fabrics, braided fabrics, knitted fabrics, unidirectional fabrics or multiaxial laid fabrics.

12. Method according to claim 7, wherein the resin filler film comprises a preform.
